(19) United States
(12) Patent Application Publication
(10) Pub. No.: US 2016/0148287 A1
(43) Pub. Date: May 26, 2016

(54) LUNCH ORDER COMMUNICATION

(71) Applicant: Peach Labs, Inc., Seattle, WA (US)

(72) Inventors: Denis Bellavance, Seattle, WA (US); Nishant Singh, Seattle, WA (US); Chenyu Wang, Seattle, WA (US); Nino Masaki Tokuda, Seattle, WA (US)

(21) Appl. No.: 14/939,931

(22) Filed: Nov. 12, 2015

Related U.S. Application Data
(60) Provisional application No. 62/082,906, filed on Nov. 21, 2014.

(51) Int. Cl. G06Q 30/02; G06Q 20/32; G06Q 20/40; H04W 4/14; G06Q 50/12

(52) U.S. Cl. CPC G06Q 30/0282; H04W 4/14; G06Q 50/12; G06Q 20/40; G06Q 20/3255

(57) ABSTRACT

Systems and related methods for providing ordering and delivery of goods and services from a merchant are discussed herein. A determination that a user is no longer eligible for an offer of an item may be performed in response to receiving input from the user about the offer. The determination may be based at least in part on information that identifies a first time period when the input was provided by the user and a second time period associated with the offer. In embodiments, information indicating a state for the offer may be updated based on the determination that the user is no longer eligible for the offer. A new offer may be identified for a different item provided by the third party based on the updated information indicating the state for the offer and transmitted to the user.

### CROSS-REFERENCES TO RELATED APPLICATIONS

This application claims the benefit of U.S. Provisional Application No. 62/082,906, filed Nov. 21, 2014, and is related to application Ser. No. 14/939,709, filed on the same day herewith, Attorney Docket No. 097287-0956893 (000110US) entitled “Lunch Order Management,” the entire contents of which are incorporated by reference herein.

### BACKGROUND

Consumers now have more choices than they have ever had in the past. As business transactions become easier, it has become increasingly important for merchants to distinguish themselves by serving a larger number of customers while at the same time providing greater convenience. For consumers, this convenience often comes at a cost. Because of the time and expense involved in delivering to a single consumer, delivery costs can make ordering goods and services from a merchant prohibitively expensive.

### BRIEF SUMMARY

There are disclosed systems and methods which provide for a system of providing a group of customers with goods and services. In some embodiments, customers seeking the same good or service may be aggregated in order to reduce delivery costs. In these embodiments, merchants may be able to take advantage of economies of scale in both the manufacture and delivery of the good or service.

In some embodiments, a merchant may be selected to provide a good or service based on factors such as merchant availability, rating, or merchant location. In some embodiments, each customer (or a subset of customers) of a group of customers may be notified of the availability of a good or service at the customers' location. Upon receiving a request for the good or service from a customer, the merchant may be authorized to provide the good or service to the customer at the customer's location. In some embodiments, a receiving station, such as a bin or vending machine, may be placed at the customers' location for easy, yet secure, retrieval of a good by each customer.

An embodiment of the disclosure is directed to a computer-implemented method for meal order management. The computer-implemented method maintains information indicating a state of a workflow associated with an offer for a meal provided by a third party. The computer-implemented method includes updating the state of the workflow in response to transmitting an offer for the meal to a user device of one or more users. The one or more users may be selected on behalf of the third party and the offer may be transmitted through a first message channel as a first short message service message to the user device. In embodiments, the computer-implemented method may include receiving a second short message service message that includes input about the offer from the user device where the second short message service message is provided via the first message channel. The computer-implemented method may update the state of the workflow based on the input received from the user device and transmit, through a second message channel, instructions to a computing device associated with the third party. The instructions may authorize preparation and delivery of the meal to the one or more users based on the state of the workflow.

An embodiment of the disclosure is directed to a computer system having one or more processors and memory that includes instructions executable by the one or more processors for meal order management. The computer system may maintain first information that indicates a state of a workflow for an offer of a service provided by a third party. The computer system may transmit second information about the offer to a cluster of users selected on behalf of the third party. In embodiments, the second information may be transmitted via a first message through a first message channel to a user device of the cluster of users. The computer system may receive, through the first message channel, a second message that includes input about the offer from the user device of a user and update the state of the workflow based on the received input. The computer system may determine an alternative offer is being requested by the user based on the updated state of the workflow and the received input and transmit a third message about an alternative offer to the user device of the user. The third message may be transmitted through the first message channel.

An embodiment of the disclosure is directed to a computer-readable medium that stores executable instructions for meal order management. The executable instructions may be executed by a processor of a computer system. The executable instructions may include determining that a user is no longer eligible for an offer of an item provided by a third party in response to receiving a first short message service message from a user device of the user. The first short message service message may be received through a first message channel and comprise input about the offer for the item provided by the third party. The determination that the user is no longer eligible for the offer may be based at least in part on first information indicating a first time period for when the input was received and a second time period associated with the offer of the item. The executable instructions may include updating second information that indicates a state of a workflow for the offer of the item based on the determination that the user is no longer eligible for the offer. In embodiments, the executable instructions may identify a new offer for a different item provided by the third party based on the updated state of the workflow and transmit a second short message service message to the user device of the user about the new offer. The second short message service message may be provided to the user device of the user through the first message channel.

### BRIEF DESCRIPTION OF THE DRAWINGS

Various embodiments in accordance with the present disclosure will be described with reference to the drawings, in which:

FIG. 1 illustrates a basic overview of some features of the current disclosure for an order management feature, according to embodiments;

FIG. 2 illustrates an example of a system architecture in which techniques for an order management feature may be implemented, according to embodiments;

FIG. 3 illustrates an example workflow diagram for an order management feature, according to embodiments;

FIG. 4 illustrates an example workflow diagram for an order management feature, according to embodiments;

FIG. 5 illustrates an example workflow diagram for determining an order conversion score associated with an order management feature, according to embodiments;

FIG. 6 illustrates am example workflow diagram for an order management feature, according to embodiments;

FIG. 7 illustrates an example order management module, according to embodiments;

FIGS. 8A-8B illustrates an example user interface for a product offering provided by an order management feature, according to embodiments;

FIG. 9 illustrates an example user interface for a product offering provided by an order management feature, according to embodiments;

FIG. 10 illustrates an example user interface for a product offering provided by an order management feature, according to embodiments;

FIG. 11 illustrates an example user interface for a product offering provided by an order management feature, according to embodiments;

FIG. 12 illustrates an example user interface for a product offering provided by an order management feature, according to embodiments;

FIG. 13 illustrates an example receiving station for receiving a shipment and/or delivery of a product provided by an order management feature, according to embodiments;

FIG. 14 illustrates an example flow diagram for an order management feature, according to embodiments;

FIG. 15 illustrates an example flow diagram for an order management feature, according to embodiments; and

FIG. 16 illustrates an example flow diagram for an order management feature, according to embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein include implementations for securely providing customers with goods and services from merchants while reducing or eliminating delivery costs as part of an order management feature provided by a service. In some embodiments, customers seeking the same good or service may be aggregated in order to reduce delivery costs. In these embodiments, merchants are able to take advantage of economies of scale in both the manufacture and delivery of the good or service. In accordance with at least one embodiment, a computer system associated with an order management service may implement the order management features described herein. In embodiments, the service may select an appropriate third-party for preparing and delivering an item to a group of customers (e.g., users). In some examples the third-party may deliver the item to a common location identified for the group of users. In an embodiment, the third-party may deliver the item and/or goods to a secure area (e.g., vending machine) for pick up by the group of users. The secure area may be located in a common location that is within a certain geographic distance from each user in the group of users.

In embodiments, the service may maintain information that identifies a state of an offer from a plurality of offers for one or more third parties providing the plurality of offers. The information about the state of an offer may be utilized by the service to determine an action in a workflow for ordering and delivery of items, service, and/or goods to a user from a third-party. In accordance with at least one embodiment, the service and computer system may utilize the information about the state of the order to take actions including providing information to a user about an alternative option of the offer. For example, a user may be notified of an offer for a meal prepared by a third-party and in response to the notification request a vegetarian option of the meal. The vegetarian option, however, may be prepared by a different third-party. In some examples, the service and computer system may enable or authorize the charge or debit of an account associated with a user based on input received from the user about an offer. In an embodiment, the information about the state of an order may indicate that the charge to the account is declined and that the user should be directed to a registration interface, web page, or application for updating and/or adding a new charge account for offers provided by the service.

The service may generate and transmit a message to a user prompting the user to verify the cancel of an order based on the information about the state of an order and a certain time period. In embodiments, the service may generate and transmit a message to a user informing them that an offer has expired based on the information indicating the state and a certain time period associated with the offer or third-party. In such cases, the service may generate and transmit a message or notification informing the user that another and/or different offer is available for order from the same third-party. In an embodiment, the user may provide input indicating a desire to order a certain number of items included in the offer. For example, the user may provide a numeral such as 9 as input indicating that the user would like to order 9 meals included in an offer prepared by a third-party. In accordance with at least one embodiment, the transmission of notifications, input, responses, requests and/or messages may be conducted via an available network and any form of electronic communication (e.g., short message service (SMS) messages) and/or user interfaces presented via a software application configured to run on a user device associated with a user.

In a non-limiting example, the service implemented by a computer system may identify a particular group of users in a downtown metropolitan area for a particular calendar date and select an appropriate third-party to prepare and deliver a meal to a common location associated with the particular group of users. In an embodiment, the particular group of users may be identified based on a geographic distance between each user in the group of users. The service may notify each user of the group of users about an offer for a meal prepared by a third-party on the particular calendar date via a text message (e.g., SMS) transmitted to each users mobile computing device. In response to providing the offer notification, the service may receive a number of responses, via text messages, from users of the group of users indicating a desire to order or participate in the offer for the meal. The service may notify the third-party about the number of orders and authorize the third-party to prepare and deliver the meals to a common location associated with the group of users. As described herein, the responses provided by the users may indicate a desire for alternative options or the input may indicate a modification to the number of orders for a particular user in the group of users (i.e., ordering more than one meal). The service may generate and provide instructions for an optimized route to deliver, by the third-party, the meals to the common location associated with the group of users. Upon receiving an indication from the third-party that the meals have been delivered to the common location, the service may generate and notify each user about the successful delivery to the common location and request a review of the food and/or of the third-party by the user.

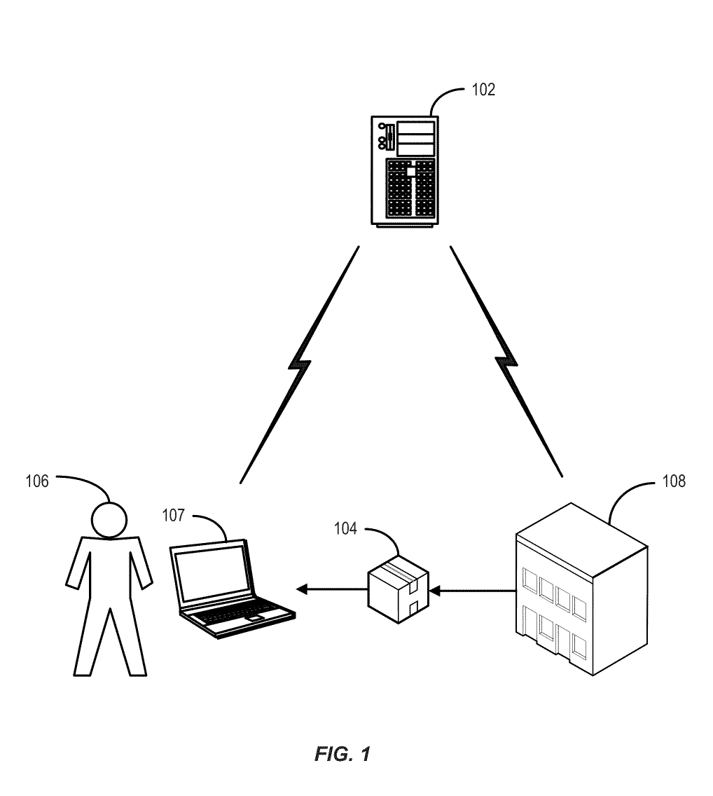

FIG. 1 illustrates a basic overview of some features of the current disclosure for an order management feature, according to embodiments. FIG. 1 includes a service provider computer 102 (e.g., one or more servers and/or computers configured to implement the order management features described herein) that may select a product 104 to present to a customer 106 (e.g., via a user device 107). The customer may be one of a group of customers that are selected for being presented the product 104 on behalf of a third-party provider 108 or as part of the service described herein. The selection of the customer, the group of customers, and a third-party provider is described in more detail below. In some embodiments, the customer 106 may be notified of the availability of the product 104 and may be able to respond to that notification. In embodiments, the customer 106 may be notified about the availability of the product 104 via a short message service message or user interface notification that is configured to be presented on the user device 107. In some embodiments, the user device may include any suitable mobile phone, mobile computing device, tablet computing device, desktop computing device, or video game computing device.

In an embodiment, the customer 106 may provide a response indicating that s/he is interested in the product 104. In response to receiving the response or input from the customer 106, the service provider computer 102 may submit an order to the third-party provider 108, who may deliver the product to the customer 106. For example, the third-party provider 108 may be a restaurant, and a customer 106 may receive a Short Message Service (SMS) message from the service provider computer 102 describing an available lunch option. In this example, the customer 106 could then respond to the service provider 102 via SMS (e.g., through the same SMS channel initially received by the customer 106) or through a graphical user interface on the user device 107 (such as a cell phone). In this example, the service provider would then order the lunch from the restaurant to be delivered to the customer 106. In some embodiments, the service provider computer 102 may generate and transmit instructions to the third-party provider 108 for delivering the lunch to the customer 106 or to a common location associated with the customer 106 and one or more other customers. The instructions that are generated and transmitted to the third-party provider 108 may enable the third-party provider 108 to take an optimal route of delivery from a location of the third-party provider 108 to a common location associated with the user 106 and one or more other users.

In an embodiment, the service provider computer 102 may create one or more message channels between the service provider computer 102 and one or more customers (such as customer 106). The message channels may be generated utilizing a user's phone number and a short messaging service message application of the user device 107. In accordance with at least one embodiment, the service provider computer 102 may generate and maintain one or more workflows for distributed customer orders or meal management. The workflows may indicate actions for the service provider computer 102 to take for distributed customer orders or meal management. The service provider computer 102 may update the workflow for an order from a user (such as customer 106) based on the notifications transmitted to the user device 107 and the responses received from the customer 106 via the user device and message channel formed by the short message service messages communicated between the parties. In embodiments, the service provider computer 102 may form a dedicated channel of communication with each user of a group of users (such as customer 106) utilizing a short message service messaging application on the user device 107 or a software application configured for the user device 107. The software application may include user interfaces that enable the user to interact with notifications provided by the service provider computer 102 and communicated via the dedicated channel to the user device, and the user interfaces may further enable the user to provide responses to the service provider computer 102 via the same dedicated channel.

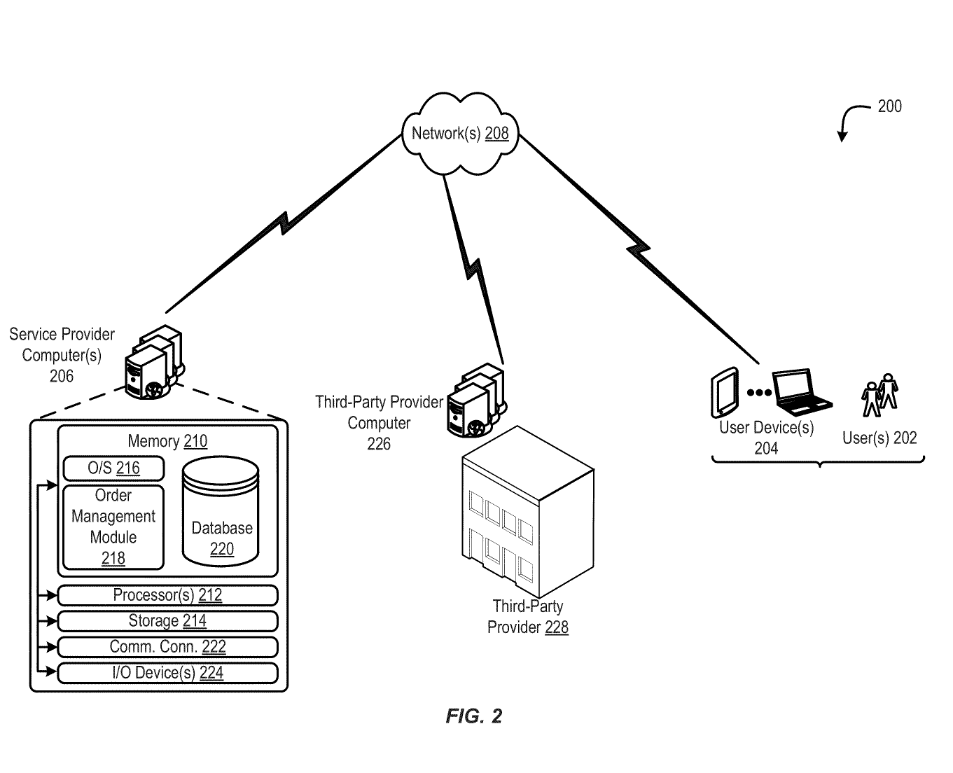

FIG. 2 illustrates an example of a system architecture in which techniques for an order management feature may be implemented, according to embodiments. In architecture 200, one or more consumers and/or users 202 may utilize user devices 204. In some examples, the user devices 204 may be in communication with one or more service provider computers 206 via one or more networks 208. or via other network connections.

The user devices 204 may be any type of computing device such as, but not limited to, a mobile phone, a smart phone, a personal digital assistant (PDA), a laptop computer, a desktop computer, a server computer, a thin-client device, a tablet PC, etc. Additionally, user devices 204 may be any type of wearable technology device (such as a watch, earpiece, glasses, etc.) that includes one or more processors capable of processing user input. The user device 204 may also include one or more sensors for receiving user input, such as an accelerometer, camera, infrared sensor, etc.

In some examples, the networks 208 may include any one or a combination of many different types of networks, such as cable networks, the Internet, wireless networks, cellular networks, and other private and/or public networks. While the illustrated example in FIG. 1 above discusses the users 202 responding to a service notification via SMS, the described techniques may equally apply in instances where the users 202 interact with the service provider computers 206 via the user device 204 over the network via a software application configured to run on the user device 204. In embodiments, the software application may be generated and maintained by the service provider computers 206 on behalf of the service described herein. The users 202 may register for, download, and install the software application associated with the service associated with the order management features described herein. In some embodiments, a user device 204 may be associated with an account, such that a user 202 is able to log in or validate their identity through the user device 204. The account may enable the user to identify or associate an appropriate monetary account for charging or debiting when ordering items from a third-party as described herein.

In one illustrative configuration, the service provider computers 206 may include at least one memory 210 and one or more processing units (or processors) 212. The processor(s) 212 may be implemented as appropriate in hardware, computer-executable instructions, firmware or combinations thereof. Computer-executable instruction or firmware implementations of the processor(s) 212 may include computer-executable or machine executable instructions written in any suitable programming language to perform the various functions described herein for the order management features.

The memory 210 may store program instructions that are loadable and executable on the processor(s) 212, as well as data generated during the execution of these programs. Depending on the configuration and type of service provider computers 206, the memory 210 may be volatile (such as random access memory (RAM)) and/or non-volatile (such as read-only memory (ROM), flash memory, etc.). The service provider computers 206 may also include additional storage 214, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 210 may include multiple different types of memory, such as static random access memory (SRAM), dynamic random access memory (DRAM) or ROM. Turning to the contents of the memory 210 in more detail, the memory 210 may include an operating system 216 and one or more application programs or services for implementing the features disclosed herein including at least an order management module 218 and/or a database 220 for storing, updating, and maintaining information associated with embodiments described herein.

The memory 210 and the additional storage 214, both removable and non-removable, are examples of computer-readable storage media. For example, computer-readable storage media may include volatile or non-volatile, removable or non-removable media implemented in any method or technology for storage of information such as computer-readable instructions, data structures, program modules, or other data. As used herein, modules may refer to programming modules executed by computing systems (e.g., utilizing processors) that are part of the user device 204 or the service provider computers 206. The service provider computers 206 may also contain communications connection(s) 222 that allow the service provider computers 206 to communicate with a stored database, another computing device or server, user terminals, and/or other devices on the networks 208. The service provider computers 206 may also include input/output (I/O) devices and/or ports 224, such as for enabling connection with a keyboard, a mouse, a pen, a voice input device, a touch input device, a display, speakers, a printer, etc.

FIG. 2 also includes a third-party provider computer 226 that is associated with a third-party provider 228. In embodiments, the service provider computers 206 may communicate with and receive input from the third-party computer 226 for authorizing orders, providing delivery instructions, generating and providing order conversion scores, or any other suitable information as described in embodiments of the order management features herein. Although FIG. 2 depicts a singular third-party provider computers 226 and associated third-party provider 228, it should be understood that embodiments described herein include embodiments for communicating with one or more third-party providers via one or more associated third-party provider computers via the networks 208.

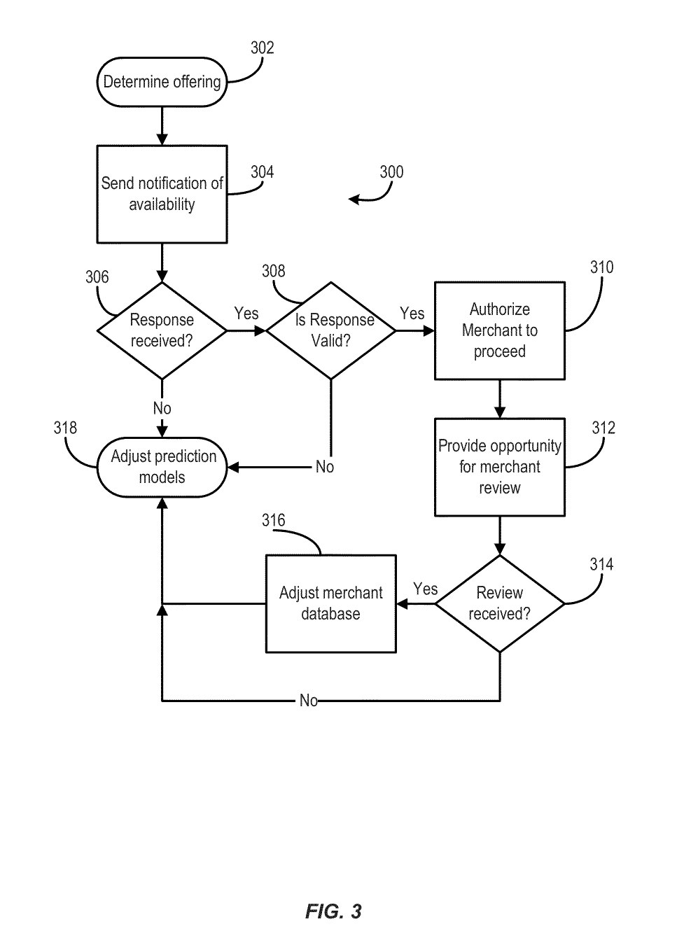

FIG. 3 illustrates an example workflow diagram for an order management feature, according to embodiments. The process 300 depicted in the workflow diagram of FIG. 3 may be implemented by the service provider computer 206 and/or the order management module 218 from FIG. 2. Some or all of the process 300 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

At 302, the order management module 218 may generate a product offering for a group of customers. In some embodiments, customers may be grouped by location. For example, customers may be grouped because they are located in the same building, on the same floor of a building, or on the same campus. In some embodiments, customers may be grouped because they work for the same company. For each group of customers, a third-party service provider (e.g., one that is not related financially to the service provider) may be selected to provide a service (which may include a service to deliver an item or meal) to that group of customers at the customers' location. In some embodiments, the product being offered may be selected by the order management module 218. In these embodiments, the selection of a product may be based on prior customer reviews of products, demonstrated preferences for particular products, or it may be chosen to fit a particular theme. For example, where the order management module 218 is generating and/or identifying a food offering, it may select tacos as the product in order to honor a Taco Tuesday theme associated with the group of customers. In some embodiments, the product may be chosen by the third-party service provider. Using an example in which the third-party service provider is a restaurant, the restaurant may determine that it can provide a large quantity of a Kung Pao Chicken for the customer group. In that example, Kung Pao Chicken would be selected as the product that would be offered to the group of customers.

In addition to selecting a product offering, the order management module 218 may also select a merchant (or third-party service provider) to provide the product at 302. In some embodiments of the disclosure, the merchant 226 may be selected from one of a plurality of merchants listed in the database 220. In some embodiments, a merchant may be selected from the merchant database because of its close proximity to the customer. For example, in an embodiment in which the merchant is a restaurant, the restaurant may be selected because of its close proximity to the customers' building. In some embodiments, a merchant may be selected because of the type of product that it offers, a minimum number of products per order, or a maximum number of products per order. For example, in an embodiment in which the merchant is a restaurant, the restaurant may be selected because of the type of food (e.g., nationality) that it serves (e.g., Mexican, Italian, etc.). In some embodiments, merchants may be selected as a result of a bidding process. For example, the merchant 226 may have the lowest price for the service or (when applicable) it may have agreed to pay a higher commission in order to provide the service. In some embodiments, a merchant 226 may be selected based on a rating system. The rating system may be global (e.g., applied equally to all customers) or localized (e.g., the customers in a specific area do or do not like a particular merchant).

Once a product and merchant have been determined, a notification may be sent to each customer of the customer group at 304. In some embodiments, each customer will receive an SMS message describing the offer, such as a description of the product, a description of the merchant, the price of the service, etc. The customer may then provide a response to the notification. The response may be a simple “yes” or “no” reply to the SMS offer. In some embodiments, the response may include a request for an alternative option to the offer such as by providing the input “LITE,” or the like, a lower calorie option of the offer may be generated and presented to the customer via the same SMS message channel (e.g., when available). The input may also include a request to the modification of number of offers the user may wish to order. For example, the user may provide a numeral such as “3” indicating their wish to order three of the offer provided by the third-party.

At 306, the order management module 218 may determine whether a customer has responded to the notification. In the previous example, a customer may be able to respond to the notification via SMS, or s/he may select an option available in the notification itself such as by interacting with a user interface element presented via a user device associated with the customer. If the customer does respond to the notification, the order management module 218 may need to determine whether the response is valid at 308. For example, if the product is being offered for a limited time, then a response received after the expiration of that time may not be considered valid. By way of further example, if a customer is sent a notification that a lunch is available for purchase which will be delivered at 12 pm, then a response by the customer at 12:30 may be treated as invalid.

In some embodiments, the order management module 218 may consider the last message or notification to the customer and process the response in relation to it. In some embodiments, a response after the deadline may be interpreted as an early response for the next product offering (in embodiments in which the next offering has already been determined). In some embodiments, customers will be notified that their response is not valid in the event that it is found to be invalid. If the response is valid, then the order management module 218 may authorize the selected third-party provider to provide the product to the customer at 310. The third-party provider may deliver the product to the customer, or the product may be delivered to a receiving station. Once the product has been delivered to the customer, the customer may receive a notification that the delivery has been made.

Once the third-party provider has had an opportunity to provide the product to the customer, the order management module 218 may provide each customer with a chance to review the third-party provider at 312. At 314, the order management module 218 may determine whether a customer has responded to the chance to review the third-party provider. If a review is received, then the order management module 218 may adjust its ratings of merchants or products based on that review at 316. In some embodiments, this may affect future offerings determined by the order management module 218 at 302. In some embodiments, the reviews of merchants or products may be utilized to determine the grouping, aggregation, or clustering of users for future offers, and/or utilized to determine an appropriate third-party provider for the group of customers. The review process may be implemented using the same SMS channel used for the item offer and order. In some embodiments, the review process may be implemented via user interfaces presented in a software application of the user device.

In some embodiments, the order management module 218 may also attempt to provide third-party service providers with sales predictions or estimates prior to making an offering. Sales predictions may take into account a number of factors, including (but not limited to) past sales, the day of the week, the number of customers from a group that normally order, the type of product offered, etc. Each time that a response is received from a customer (or not received), the prediction model may be updated at 318. Additionally, the prediction model may take into account invalid responses and customer ratings. In accordance with at least one embodiment, the service provider computers 206 and/or the order management module 218 may generate and utilize one or more predictive models to further generate an order conversion score utilizing the above noted factors or any other suitable factor described herein. The generated order conversion score may be communicated to the selected third-party provider to enable the third-party provider to predict the number of acceptances for the offer for a particular group of customers/users. This can be useful for third-party providers whose goods, items, and/or meals have a large preparation time. In embodiments, the generated order conversion score may be utilized to select an appropriate merchant for a cluster or group of users. For example, the service may select a particular merchant from a group of merchants based on the merchant that has the highest order conversion score for a particular group of users.

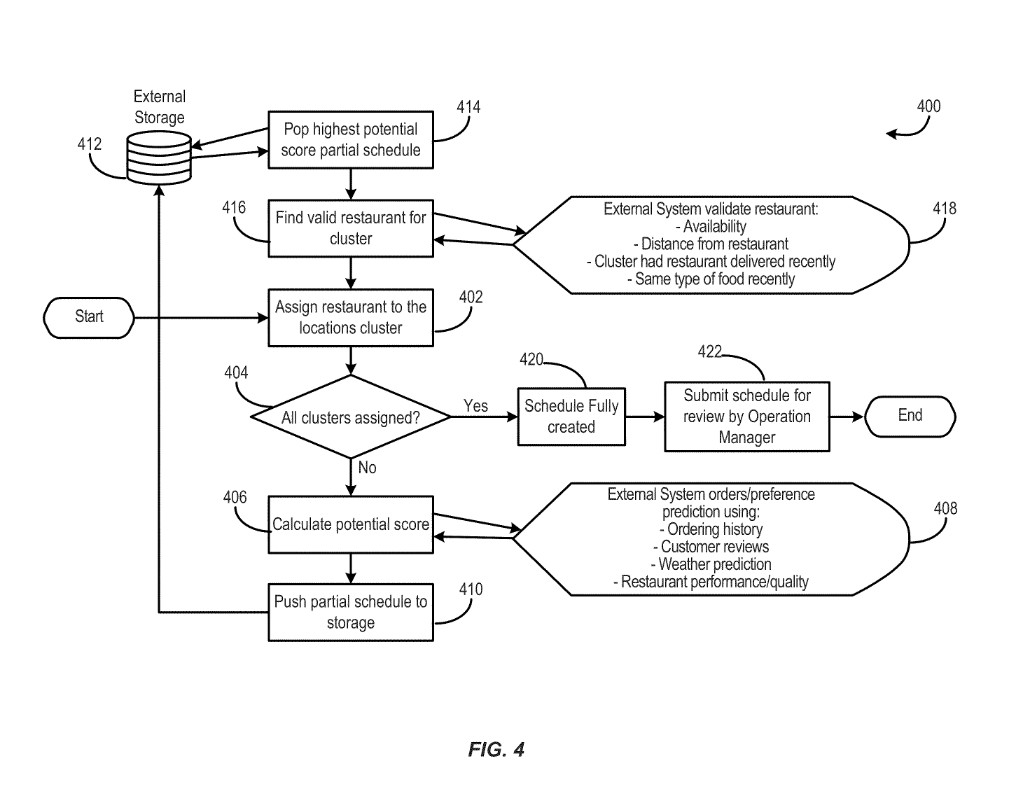

FIG. 4 illustrates an example workflow diagram for an order management feature, according to embodiments. The process 400 depicted in the workflow diagram of FIG. 4 may be implemented by the service provider computer 206 and/or the order management module 218 from FIG. 2. It should be noted that although FIG. 4 illustrates the selection and communication with one or more restaurants, embodiments described herein can apply to other third-party providers such as merchants that provide a variety of goods including items or tickets for events. The process of FIG. 4 is illustrated in a cyclical workflow to represent the dynamic nature of selecting and updating groups of users and appropriate merchants for particular calendar days. In embodiments, the service may maintain a set of policies or rules which indicate that a particular selected group of users is not provided a same type of food on consecutive calendar days or that a particular third-party provider is not selected for offering an item to the selected group of users on consecutive calendar days. The rules and policies enforced by the service may ensure variety for the selected group of users and the ratings provided by the users may ensure that each third-party provider offers items that are desired by the group of users. The process 400 can include the assigning, by the service provider computer 206, of a restaurant to a common location for a cluster of users at 402. The selection of an appropriate restaurant and determination of clusters for the users associated with the order management feature/service are described in more detail below.

The process 400 may include determining whether all potential clusters have been assigned at 404. For example, the service may identify that the users associated with the service have not been assigned to an appropriate cluster and therefore have not been notified of an offer from a selected third-party provider. In such cases, the process 400 may include calculating a potential order conversion score at 406. In embodiments, the generated score may be determined by the service provider computers 206 utilizing a number of factors 408 including the order history for the cluster of users, the overall customer reviews for the meal type, offering, and/or item/service, information indicating the weather for the cluster of users, and reviews for the third-party providers (including restaurants that prepare a meal for offer to the users). The process 400 may include storing a partial schedule 410 in external storage 412. The external storage 412 may be an example of database 220 from FIG. 2 and associated with and accessed by the service provider computers 206. The partial schedule may include information for determined clusters of users and selected third-party providers for the determined cluster of users for a portion of days for an upcoming week in a calendar year. In embodiments, the service continuously updates and generates a schedule for selecting users and appropriate third-party providers to offer items to the users and ensure variety of items offered to the users.

The process 400 may include identifying a partial schedule that includes the highest potential conversion score at 414 and finding an appropriate restaurant 416 for a cluster of users associated with the partial schedule 414. In accordance with at least one embodiment, selecting an appropriate restaurant or third-party provider 416 can be based at least in part on a number of factors 418 including availability of the third-party provider, geographic distance of the third-party provider from a common location identified for the cluster of users, whether the cluster has recently been delivered an item from the particular third-party provider recently (i.e., within a certain time range), and/or whether the cluster has recently been delivered a particular item type (i.e., a same type of food) recently such as within a certain time range. In an embodiment, upon determining that all clusters have been assigned a selected third-party provider 404 the process may include identifying that a full schedule for an upcoming calendar week has been determined 420. In some embodiments, the process 400 can include submitting the fully created schedule 420 for review by an operation manager associated with the service at 422. In an embodiment, the schedule may be utilized by the service provider computers 206 to generate the messages for transmitting to the users and third-party providers as described herein.

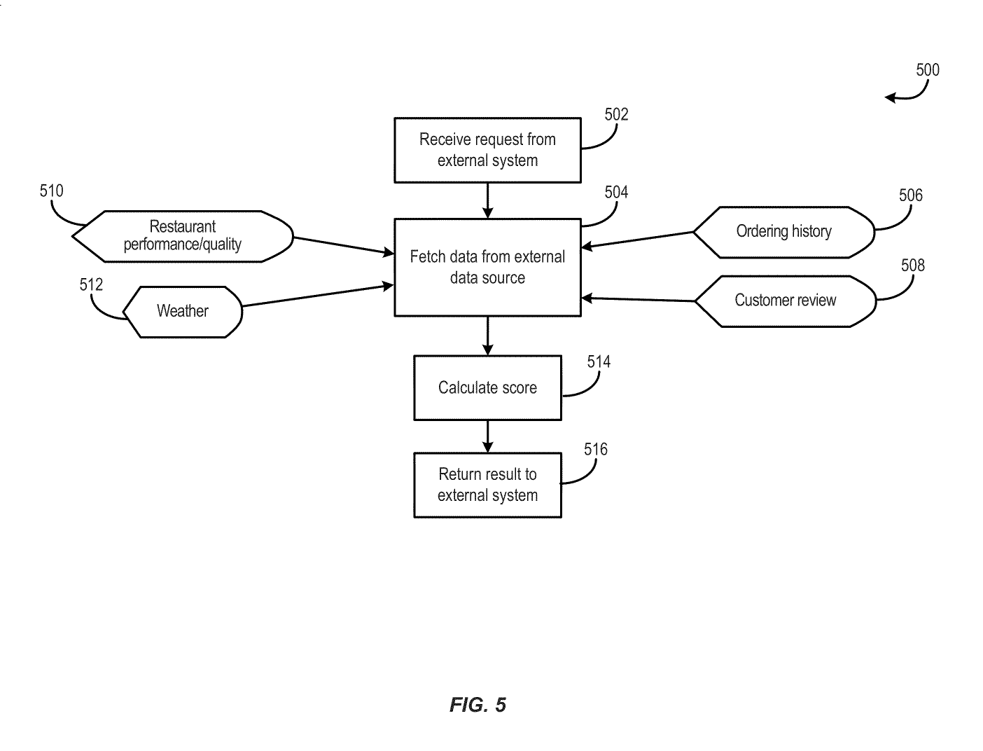

FIG. 5 illustrates an example workflow diagram for determining an order conversion score associated with an order management feature, according to embodiments. The process 500 depicted in the workflow diagram of FIG. 5 may be implemented by the service provider computer 206 and/or the order management module 218 from FIG. 2. It should be noted that although FIG. 5 depicts communication with an external system, embodiments described herein include determining an order conversion score by the service provider computers 206 absent communication with an external system. In some embodiments, the request received for the order conversions core may originate from a third-party provider querying for purposes of preparation of a meal or item that requires a head start. The process 500 of FIG. 5 may include receiving a request from an external system 502 for an order conversion score. In embodiments, the order conversion score may represent the probability of ordering by a group of users for a particular item offered by a third-party provider. In some embodiments, the request 502 may be communicated to the service provider computers 206 via one or more available networks, such as networks 208.

The process 500 may include fetching or obtaining from an external data source one or more pieces of information, data, or factors 506-512 for determining the order conversion score. As noted above, communication may be performed via networks 208 to an external data source such as an external data storage device (database) maintained by another party. In some embodiments, the service provider computers 206 have access to, maintain, and may obtain the factors 506-512 without communicating with an external party or across networks 208. In FIG. 5 the depicted factors include an ordering history 506 of items, customer reviews for the ordered items 508, reviews or ratings of a third-party provider such as restaurant performance and/or quality information 510, and weather conditions or information for the cluster of users and/or the third-party provider 512. In embodiments, the service provider computers 206 may calculate or generate the order conversion score at 514 based at least in part on the factors 506-512. Although factors 506-512 are illustrated as being utilized to calculate the order conversion score 514, one or more suitable factors for determining the order conversion score 514 may be utilized by the service provider computer such as demographic information associated with the cluster of users in question. The process 500 may conclude by providing the order conversion score 514 to an external system at 516 such as a computer system associated with a third-party.

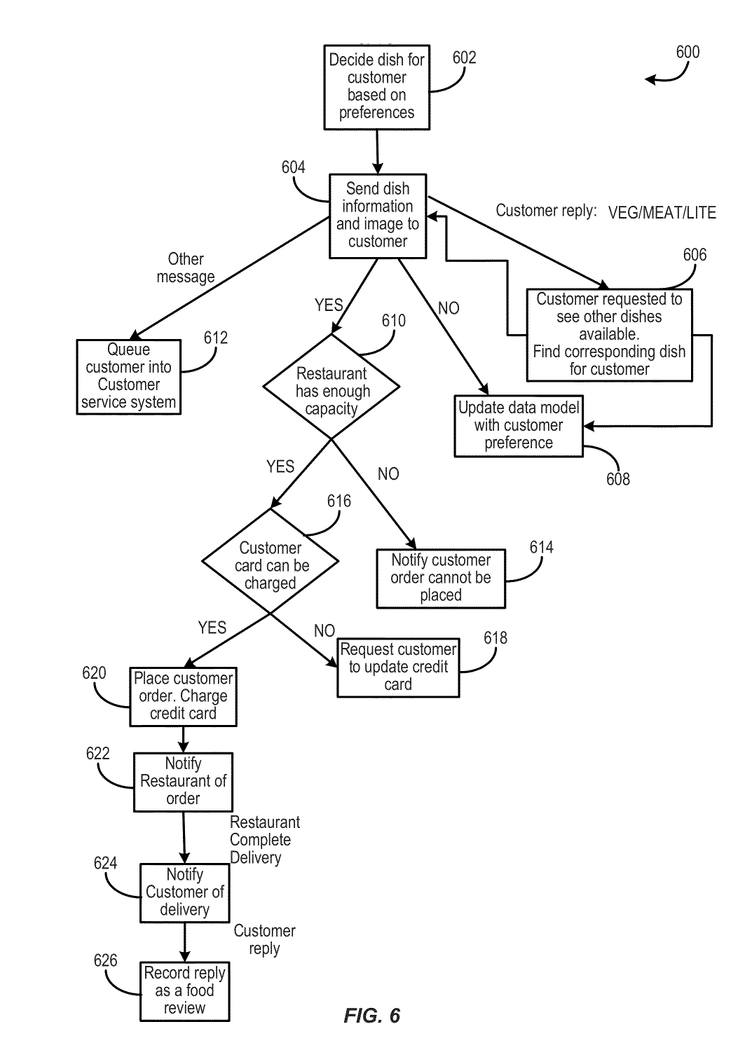

FIG. 6 illustrates am example workflow diagram for an order management feature, according to embodiments. The process 600 depicted in the workflow diagram of FIG. 6 may be implemented by the service provider computer 206 and/or the order management module 218 from FIG. 2. The process 600 depicted in FIG. 6 may include communication, via network 208, between a user device 204 associated with a user 202, a third-party provider computers 226 associated with a third-party provider 228, and the service provider computer 206 and/or the order management module 218. The process 600 may include selecting a dish for a customer or group of customers based on preferences associated with the group of customers at 602. For example, the service provider computer 206 may select the appropriate dish based on the factors 506-512 described above in FIG. 5 and/or other suitable factors such as user preferences identified in a user profile for each user. For example, the order management module 218 may maintain user profiles that indicate allergies, food preferences, serving sizes, etc. that are preferences of each user that registers for the service described herein.

The process 600 may include sending information about a meal to a customer that includes an image of the meal offered by a third-party provider at 604. As described herein, the transmission of information identifying the offer of a dish including an image of the dish may be performed via a SMS text message or via a user interface element associated with a graphical user interface presented on the user device of a user. FIG. 6 includes several options 606-612 based on the input received from the user about the dish offered at 604. The user may provide a response via the same channel that they received the offer or via a different channel. A user may provide a response indicating that they wish to see other options or dishes available from the selected third-party provider at 606. For example, the user may respond with “VEG,” “MEAT,” or “LITE,” to be presented with other options than the offered dish. The user may also respond with “NO” indicating that they do not wish to participate or order the item/meal offered by the third-party provider at 608. In embodiments, based on the input of the user (606 or 608) the service may update the customer preferences for the particular user.

In accordance with at least one embodiment, the process 600 may include a determination of whether the third-party provider or restaurant has enough capacity for the orders submitted by the users at 610. In some examples, the users may respond at 604 with input or responses that are not recognized by the service provider. In such cases, the process may include transferring, queuing, or connecting the user with a customer service system at 612. Going back to the determination of whether the restaurant has enough capacity to handle the order volume 610, if the restaurant does not have the capacity 610, a notification may be generated and provided to the customer that the order cannot be placed at this time 614. In some examples, the service provider computers 206 may identify another cluster to include the user in when the restaurant has reached capacity so that the user has an opportunity to respond to a different offer. The process 600 may include a determination of whether the customer can be charged for the order at 616. If the customer cannot be charged, such as information is obtained that an account, credit card, or debit transaction is denied, a request may be generated and provided to the customer requesting an update of account information which may be charged at 618. In embodiments, the notification or request may direct the user to a web page and/or user interface for updating account information or providing account information that can be charged for an order as described for the order management feature herein. In an embodiment, the user may cancel the order at this point until a proper account can be identified and communicated to the service.

In an embodiment, if the customer can be properly charged for the order 616, the process 600 may place the order with the third-party and charge the account of the customer at 620. In embodiments the service may notify the appropriate restaurant or third-party provider about the order at 622. In an embodiment, the service provider may generate and transmit delivery instructions to the restaurant or third-party provider enabling for an optimized delivery route to provide the meal/item to the user or a common location associated with the users. The process 600 may include notifying the customer that the item and/or meal has been delivered at 624. The notification of delivery can be performed via the SMS text message channel or via another channel such as via a user interface of a software application. The process 600 may conclude at 626 by requesting and storing a reply for a review of the item/meal just delivered at 624 from the customer. The request for review 626 may be provided to the user after expiration of a time period. In embodiments, the time period may be determined by the service provider computers 206 based at least in part on preferences of the user, preferences of the cluster and/or group of users, the type of item/meal provided, or the amount of items/meals provided to the user.

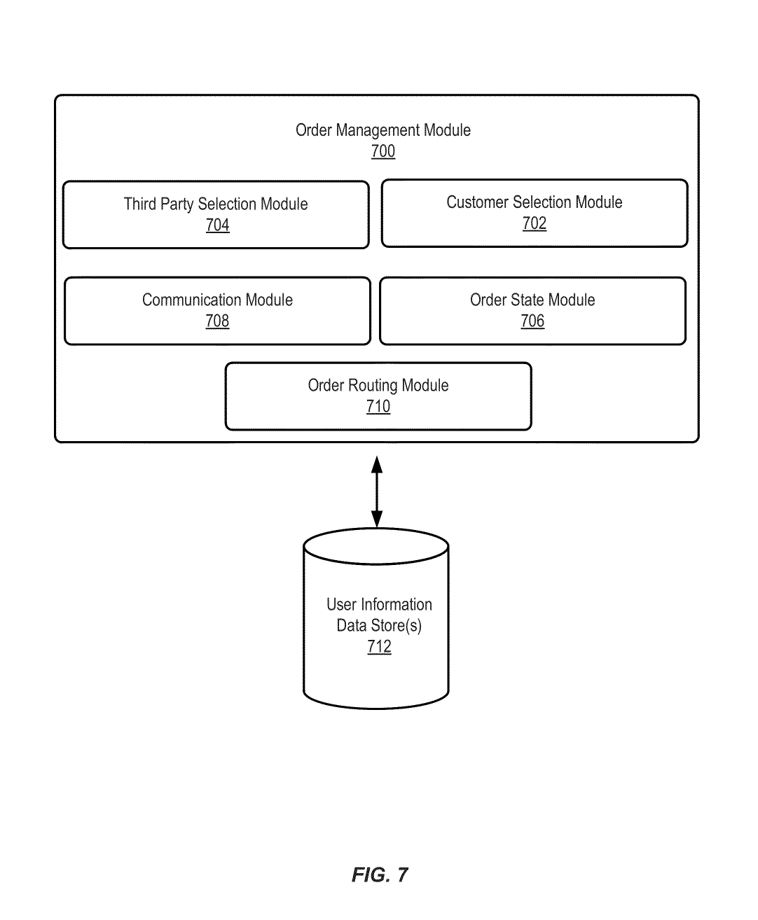

FIG. 7 illustrates an example order management module, according to embodiments. In accordance with at least one embodiment, the order management module 700 may include a customer selection module 702, a third-party selection module 704, an order state module 706, a communication module 708, and an order routing module 710 that is in communication with one or more data stores 712. The modules included within and including the order management module 700 may be software modules, hardware modules, or a suitable combination thereof. If the modules are software modules, the modules can be embodied on a non-transitory computer readable storage medium and processed by a processor in any of the computer systems described herein. It should be noted that the described processes and architectures described below can be performed either in real-time or in an asynchronous mode prior to any user interaction. The modules may be configured in the manner suggested in FIG. 7 or may exist as separate modules. The order management module 700 may be implemented by the service provider computers and order management module of FIG. 2 (e.g., 206 and 218) and the order management module 700 may be an example of order management module 218.

In accordance with at least one embodiment, the order management module 700 may be configured to determine a common location associated with a group or cluster of users for delivering the item/meal as described herein. The common location may be identified based at least in part on information identifying that the users are located in the same building, on the same floor of a building, on the same campus, block, or part of town, etc., or because they work for the same company. In an embodiment, the order management module 700 may be configured to maintain user profiles for users that are registered or are utilizing the service. The user profiles may include contact information, account information for charging orders, user preferences, and any other suitable information included in a user profile. The order management module 700 may maintain information identifying participating third-party providers and/or restaurants including items and meals offered by the third-party providers. In embodiments, the order management module 700 may be configured to generate, update, and maintain partial or complete schedules that identify the groups of users and the selected third-party providers for the group of users for a certain period of time such as a day, a week, a month, or a year.

In accordance with at least one embodiment, the customer selection module 702 may be configured to identify or select a cluster of users for pairing with a selected third-party provider as described herein. In embodiments, the customer selection module 702 may select a portion of users to aggregate into a group or cluster based at least in part on one or more factors including information indicating a willingness to travel, information indicating ease of access to travel, the physical or geographic distance between each user in a potential group of users from each other, a common geographic location, or an identification that a group of users work for a same employer. The information indicating a willingness to travel may include responses to a query about a willingness to travel, user preferences related to travel, or history choices of the user to travel to particular locations identified by the service for previous orders. The information indicating ease of access to travel or ease of travel may include information about a building or location associated with the user (i.e., how many floors, number of elevators, stairs, number of people in building), access to commuting options such as busses or subways, or other suitable demographic information for a location associated with a user. It should be noted that although some examples discuss selecting a singular group of users and an appropriate merchant, embodiments disclosed herein apply to scenarios where the customer selection module 702 identifies multiple clusters of users. Further, each cluster of users of the multiple cluster of users may be serviced by a singular merchant in some examples while in other scenarios each cluster of user is serviced by a different merchant selected according to embodiments described herein. As an illustrative example a first group of users may be selected and serviced by a first merchant, while a second group of users may be identified/selected to be serviced by the first merchant or a second merchant, and a third group of users may be identified/selected and serviced by a third merchant, etc. The customer selection module 702 may maintain one or more thresholds to associate with the information indicating ease of travel to determine whether a customer or user has an easy access to travel or a more difficult traveling from their current location to a common location or different location. For example, a low threshold may be associated with minimum travel via stairs or elevators whereas a high threshold may be associated with multiple floor travel, commuting time utilizing public commuting options, or a large geographic distance between the user and a location. The customer selection module 702 may be configured to maintain information about aggregate groups or clusters of users associated with the service based at least in part on the factors described herein.

In accordance with at least one embodiment, the third-party selection module 704 may be configured to select an appropriate third-party provider for a cluster or group of users based on one or more factors. In embodiments, the factors may include an indication of availability from a third-party provider, geographic distance from the third-party provider to the selected group or cluster of users, type of item or meal offered, order history between the selected cluster and the potentially selected third-party provider, and order capacity of the third-party provider. In some examples, a third-party provider may be limited by their resources in terms of number of orders they can fulfill at a particular time or for a particular day. Such information may be communicated to the service during registration by the third-party provider. In embodiments, the third-party selection module 704 may be configured maintain and update item and/or meal offerings provided by the third-party providers. In an embodiment, the third-party selection module 704 may be configured to receive and process delivery notifications provided by third-parties indicating that offers have been delivered. This information can drive the notification of food delivered to appropriate users and generation and transmission of requests for review of the item/meal as described herein.

In accordance with at least one embodiment, the order state module 706 may be configured to maintain information identifying a state for all orders and processing responses from users about potential offers communicated to them by the service as described herein. The order state module 706 may be configured maintain and implement one or more workflows that indicate actions to be taken by the service, third-parties, or users for order management features described herein. The order state module 706 may be configured to update the information about the state of each order based on messages provided to the user and input received from the user and/or messages provided to a third-party and input received from the third-party. The order state module 706 may be configured to update the maintained workflows based on new options implemented by the service or based on the input provided by the users or participating third-parties.

In accordance with at least one embodiment, the communication module 708 may be configured to generate and transmit messages, notifications, and queries to users or third-parties based at least in part on input from the modules 700-706 and 710. The communication module 708 may be configured to receive and process responses or input from users and third-parties and keep track of particular communication channels being utilized by each party in an order. For example, providing SMS text messages when the user has responded with a SMS text message. In embodiments, the communication module 708 may be configured to request reviews from users about the delivered item/meal or the third-party provider.

In accordance with at least one embodiment, the order routing module 710 may be configured to generate and transmit delivery routes to the participating third-parties that are delivering items to users. In embodiments, the order routing module 710 may utilize geographic information and/or traffic information about the user's location, a common location associated with the user, and the third-party provider to generate and transmit an optimum delivery route for efficient delivery of the items to the users. In embodiments, the order routing module 710 may be configured to obtain and transmit information about the delivery locations transmitted to the third-party providers including images or specific details about the delivery location. The information about the delivery locations can indicate entrances of buildings to utilize, which direction to approach from, codes to gain entry to a location, or any other suitable location information for efficient delivery of items and/or meals from third-party providers.

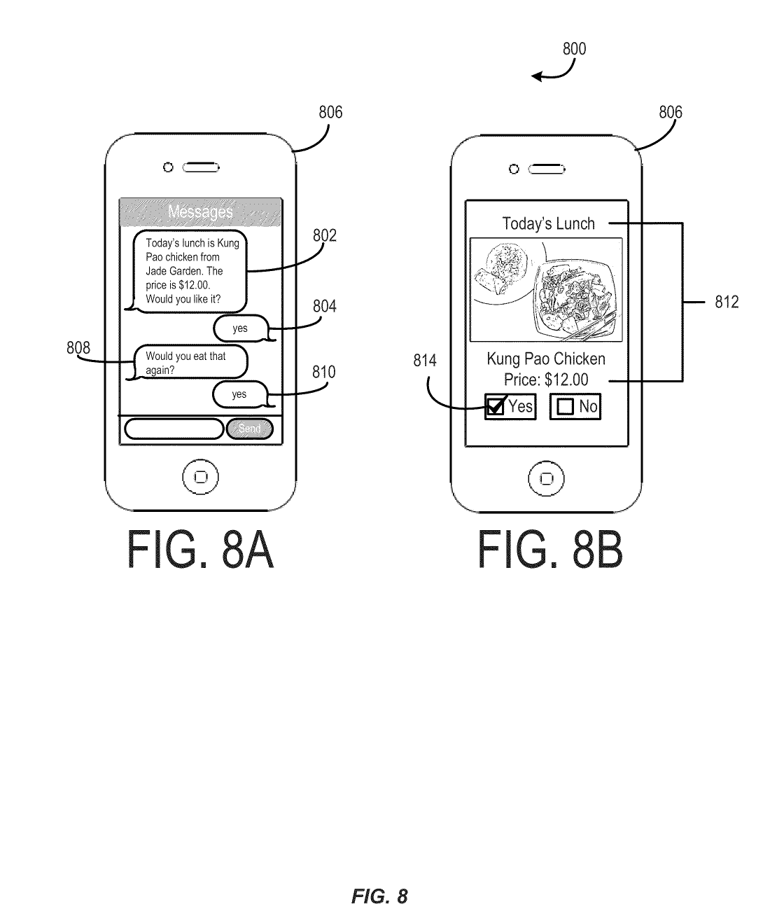

FIGS. 8A-8B illustrates example user interfaces for a product offering provided by an order management feature, according to embodiments. In some embodiments, such as the embodiments depicted in FIG. 8A and FIG. 8B, the product offering may include a product description 802. The product description may contain any number of item attributes, including a picture of the product, the product's price, availability, customer reviews, origin, nutrition information, the name of the third-party provider, etc. In some embodiments, customers may also have the opportunity to provide a response 804 to the notification. In some embodiments, customers will be able to provide the response 804 by sending (or replying to) an SMS or other message to the originator of the notification, by selecting an option in a web browser, or via email. In some embodiments, a user device 806 may be utilized to transmit the product description 802 and receive a response 804 from the user. The user device 806 may be associated with a particular user, such that any response received from that user device 806 is assigned to that user.

In the illustrative embodiment depicted in FIG. 8A, the product offering 802 is provided in an SMS message. In this example, the user is able to provide a response 804 and place an order by replying to the SMS (e.g., with “yes”). An answer of“no” or a failure to reply to the SMS message in a timely manner may result in the order not being placed. In some embodiments, a request to review 808 may also be sent to the user. In these embodiments, the user may be able to provide a response 810 (e.g., “the meal was great,” “I didn't like the peanut sauce,” etc.) by replying to the request to review 808.

In some embodiments, user responses, such as the illustrated user response 804 and a user response 810, may be sent to the same source. For example, in FIG. 8A, the user response 804 to the product offering 802 and the user response 810 to the request for review 808 may both be sent to a single recipient. In these embodiments, the service provider computers 206 may distinguish between the responses based on a number of factors. For example, the service provider computers 206 may consider the last message or notification sent to the user and process the response in relation to it. In some embodiments, a response may be distinguished based at least in part on the time of day, or a prior response received. For example, if the user response 804 was “no,” then a subsequent “yes” may not be construed as a customer response 810 to a request for review 808. Instead, the service provider computers 206 may construe a subsequent “yes” as the user changing his or her mind and ordering the meal. Alternatively, the service provider computers 206 may construe a subsequent “yes” as the user placing an order for a next product offering. In embodiments, the determination of how to interpret the responses received from the user may be based at least in part on information indicating the state of the order for the user as described herein.

In the illustrative embodiment depicted in FIG. 8B, the product offering 812 is provided in a web browser on a mobile device 806. In this example, the user may be able to provide a response and place an order by selecting an interactive element 814 on the page. An answer of “no” or a failure to select a response in a timely manner may result in the order not being placed. In some embodiments, an account login may be required in order to place an order. In some embodiments, a link to the web page with the product offering may be provided in a text message, such as via an SMS. In embodiments, the product offering 812 may also be provided via a user interface of a software application configured to run on the user device 806.

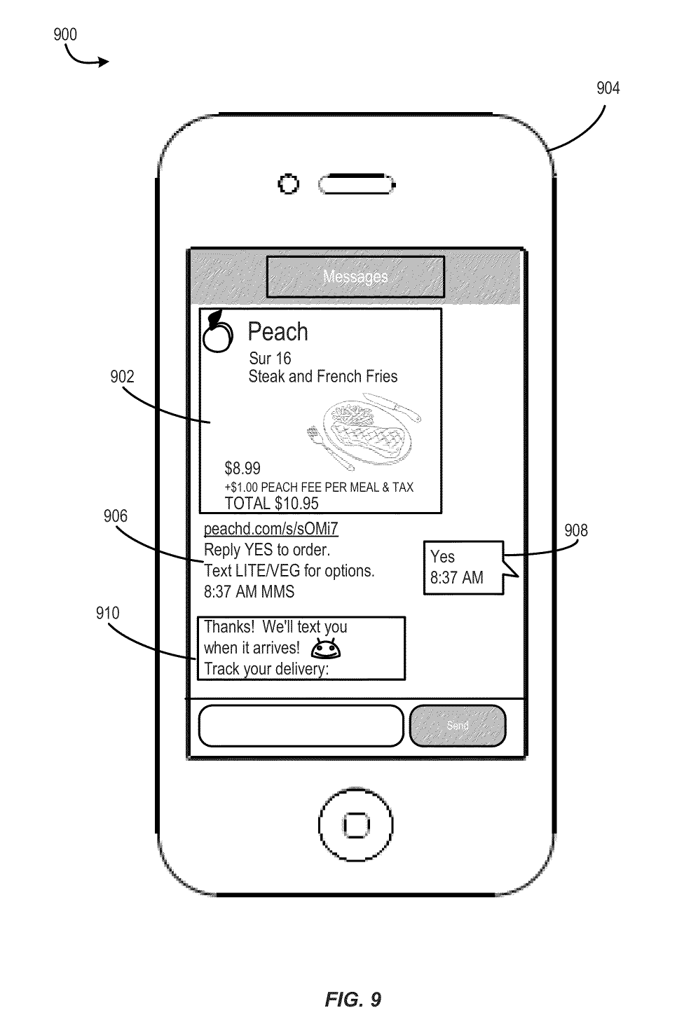

FIG. 9 illustrates an example user interface for a product offering provided by an order management feature, according to embodiments. In the illustrative embodiment depicted in FIG. 9, the product offering 902 is provided in an SMS message. The product offering 902 include text and images of the product offering including a price for the meal. The product offering 902 may be provided to a user device 904 associated with a user. In embodiments, the product offering 902 may be accompanied by instructions 906 that aid the user in replying correctly to accept the offer or to learn about other options. For example, the instructions 906 included in FIG. 9 inform the user how to order or that there are other options for the product offering included in the product offering 902. As described herein, the user may respond 908 via the same SMS message channel (e.g., with “yes”). In some embodiments, the service provider computers may generate and transmit a verification message 910 that informs the user that the order has been received. In embodiments, notifications or messages provided to the user (such as 910) may enable to the user to be directed to a tracking user interface for tracking the delivery of the product offering 902 to a common location associated with the user.

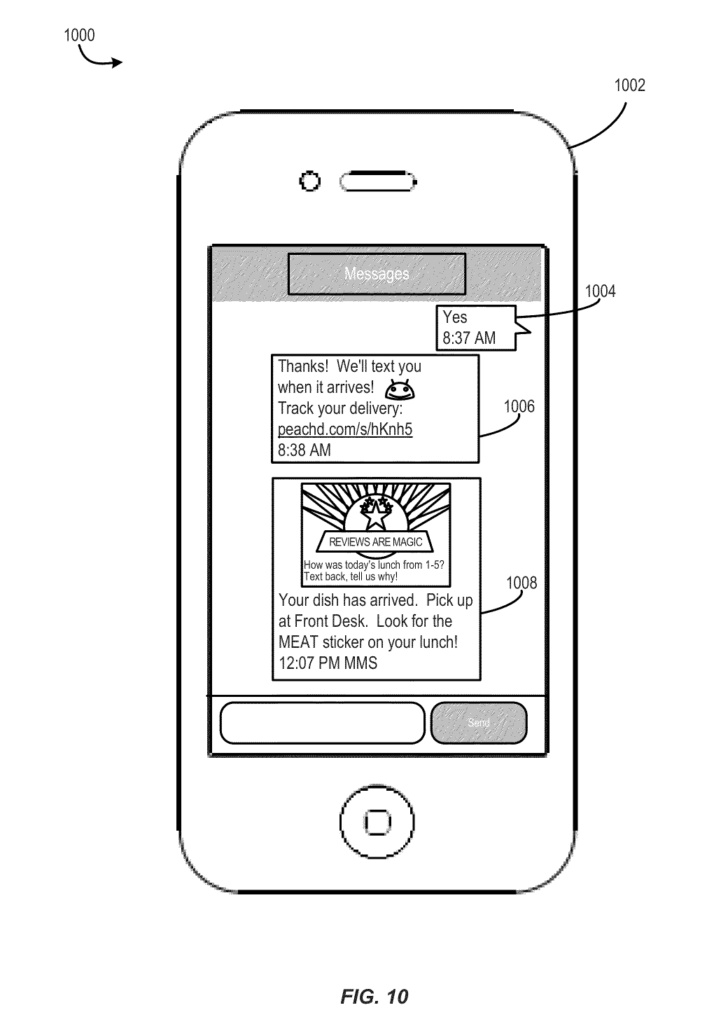

FIG. 10 illustrates an example user interface for a product offering provided by an order management feature, according to embodiments. The illustrative embodiment depicted in FIG. 10 includes a user device 1002 for presenting one or more messages 1004-1008 between a user and the service provider computers 206. FIG. 10 includes a response by a user 1004 (e.g., “yes”), provided in response to a product offering from a third-party. In response to receiving the response from the user, the service provider computers may generate and transmit one or more messages 1006 and 1008 informing the user that the order is being placed and that they can track the delivery via a web page hyper-link. In embodiments, a message or notification may be generated and transmitted to the user, via the user device 1002, indicating that the item or meal is delivered 1008 at a common location. For example, the message 1008 informs the user that the delivery is complete by the third-party and informs the user where the common location is located so the user can pick-up the delivery of the product offering.

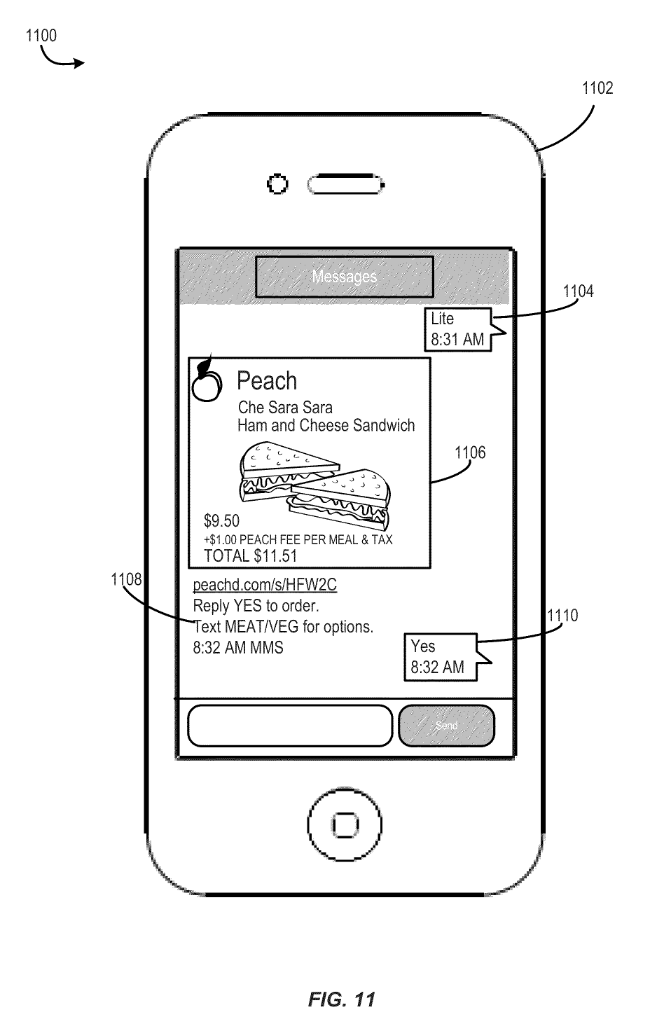

FIG. 11 illustrates an example user interface for a product offering provided by an order management feature, according to embodiments. The illustrative embodiment depicted in FIG. 11 includes a user device 1102 for presenting one or more messages 1104-1110 between a user and the service provider computers 206. FIG. 11 includes a response by a user 1104 (e.g., “Lite”), provided in response to a product offering from a third-party as described herein. As described above, responses provided by a user may indicate a request for alternative options for an offered item and/or meal. FIG. 11 includes a response 1106 generated by the service provider computers 206 in response to receiving the input from the user 1104. The alternative product offering 1106 includes text and images about a lower calorie or LITE option of a product offering previously communicated to the user and a price for the alternative option. FIG. 11 also includes instructions 1108 informing the user how to order the alternative product offering included in message 1106 and a response from the user 1110 authorizing the order of the alternative product offering. In some examples, were the user to respond at 1110 with “MEAT” or “VEG” than other alternative options would be generated and communicated to the user via the same communication channel (in FIG. 11 a SMS message channel).

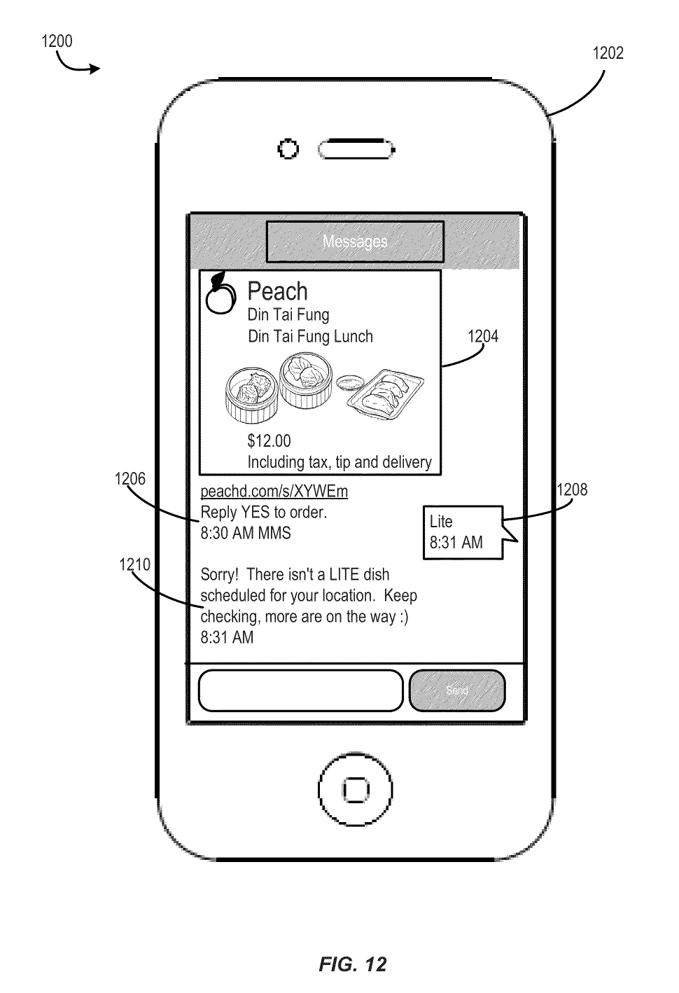

FIG. 12 illustrates an example user interface for a product offering provided by an order management feature, according to embodiments. The illustrative embodiment depicted in FIG. 12 includes a user device 1202 for presenting one or more messages 1204-1210 between a user and the service provider computers 206 according to embodiments. FIG. 12 includes a message 1204 generated and transmitted by the service provider computers 206 to a user associated with the user device 1202. The message 1204 is a product offering that includes text, images, and monetary values for ordering the product offering and instructions 1206 for ordering the product offering included in message 1204. In embodiments, the instructions 1206 and message 1204 may be communicated as one message or as two separate messages. FIG. 12 includes a response by a user 1208 (e.g., “Lite”) indicating that the user desires an alternative product offering than that included in message 1204. In some examples, the service provider computers 206 may generate and transmit a message 1210 informing the user that the requested alternative product offering is unavailable from the selected third-party. In embodiments, the user may provide further input to order the original product offering included in message 204 or to request more alternative options such as by responding with “MEAT.” However, some third-party providers may only offer one product offering without any alternative product offerings for a time period. As indicated by the text of message 1210, some third-party providers may offer different product offerings to a user of the a cluster or group based on the time of day (e.g., a breakfast option, a lunch option, or a dinner option).

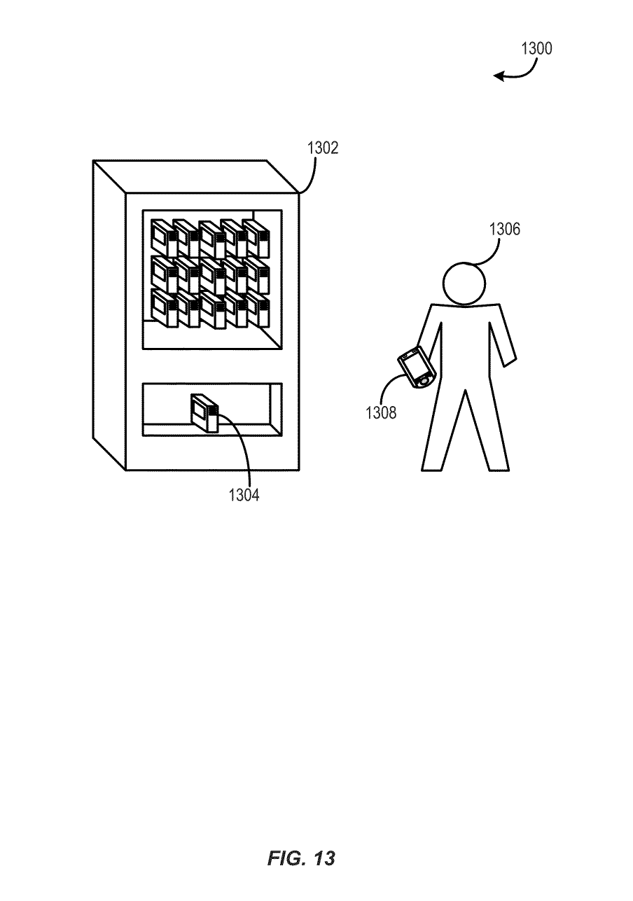

FIG. 13 illustrates an example receiving station for receiving a shipment and/or delivery of a product provided by an order management feature, according to embodiments. In some embodiments, a receiving station 1300 may be a vending machine 1302 which is able to dispense a product 1304 to each customer 1306. In some embodiments, the third-party provider is responsible for delivering the product 1304 to the receiving station 1300. Once the delivery has been made, notifications may be sent to each customer 1306 who have placed an order for the product 1304.

In some embodiments, the vending machine 1302 may validate customers 1306 through an interaction with the customer's mobile device (user device) or an interface (e.g., a touch screen or the like) on the vending machine 1302. It is envisioned that this can be done using a number of methods including, but not limited to, radio frequency identification, Bluetooth (from a user device), user name and password, or a code provided to each responding customer. In some embodiments, payment may be collected from the customer at the receiving station 1302.

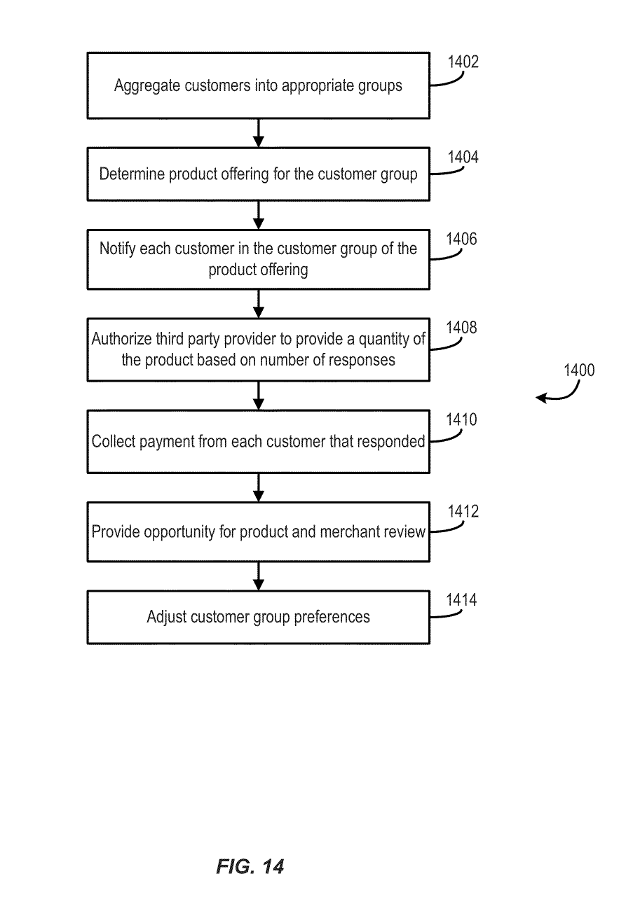

FIG. 14 illustrates an example flow diagram for an order management feature, according to embodiments. Some or all of the process 1400 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In process 1400, customers may be aggregated into appropriate groups at 1402. In some embodiments, customers within the same locations may be aggregated into a common group. Once customers have been aggregated, a product offering for that group may be determined at 1404. In some embodiments, the product offering may take into account preferences associated with one or more members of the group. In some embodiments, the preferences of each member may be weighted differently. For example, the preferences of a customer in the group who has a tendency to purchase the offered product more frequently may be more heavily weighted than a customer who infrequently purchases the offered product. In some embodiments, the product offering may be made based on attributes of the customer. Using an example in which the product is food, a customer group in which a large percentage of the customers have names associated with a particular national/geographic origin may have a higher likelihood of being offered food of that area. In some embodiments, the type of a product may be chosen because it has not been offered recently, or to create variety. In addition to determining a product offering, a third-party provider of that product may also be selected at 1404.

Once a product offering has been determined, customers in the aggregated group may be notified of the product offering at 1406, to which each member may be capable of responding. In some embodiments, customers may be sent a notification via SMS, to which the customer may reply. Upon receiving responses to the product offering, a third-party provider of the product may be provided with the quantity of product to be provided to the customer group at 1408. In some embodiments, only those customer responses received before a condition has been met will be counted. For example, when a product has limited availability, only those customers that respond such that the demand does not exceed the availability will be counted. By way of further example, product offerings may be time sensitive and customers may need to respond before a given time in order to be counted. Once the quantity has been sent to the third-party provider, the third-party provider may deliver the product to each of the customers that responded. In some embodiments, the product may be placed in a bin at the customers' location. In some embodiments, a receiving station may be set up to receive the product. For example, in some embodiments, a vending machine or other permanent or semi-permanent receptacle may be provided in order to dispense the product to each customer. This receiving station may validate customers using a number of methods including, but not limited to, radio frequency identification, Bluetooth (from a user device), user name and password, or a code provided to each responding customer.

In some embodiments, once the quantity has been sent to the third-party provider, payment for the product may be collected from each customer at 1410. In some embodiments, payment information (such as credit card information) may be stored on a customer's account. In some embodiments, a third-party payment provider may be used to collect payments from customers.

In some embodiments, customers may be given an opportunity to review or rate the product or third-party provider at 1412. Based on the received reviews, customer preferences may be adjusted at 1414. In some embodiments, as a result of received reviews, third-party providers may be selected more or less often, or even removed from the selection process entirely. In some embodiments, particular products may be selected more or less often, or even removed from the selection process entirely as a result of received reviews. In some examples, the product or provider reviews may be provided via the same communication channel (e.g., SMS, email, web UI, etc.) as the offer for the product and/or the order of the product.

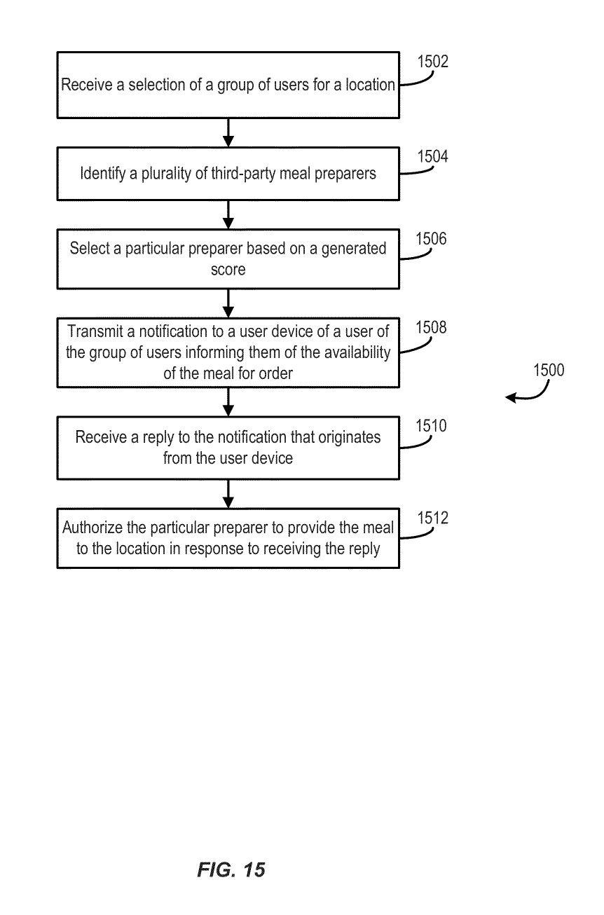

FIG. 15 illustrates an example flow diagram for an order management feature, according to embodiments. Some or all of the process 1500 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1500 may begin at 1502 by receiving a selection of a group of users associated with a location. In embodiments, the selection of the group of users may be based at least in part on a geographic distance between each user in the group or information indicating that each user is employed by the same employer. The process 1500 may include identifying a plurality of third-party meal preparers within a geographic range of the location at 1504. In an embodiment, each third-party meal preparer may have registered or agreed to participate in the service implementing the order management features described herein. The process 1500 may include selecting a particular preparer from the plurality of third-party meal preparers for preparing a meal for the group of users 1506. In some examples, the particular preparer may be selected based at least in part on a generated score. The generated score may represent a probability or order conversion score for the group of users ordering a meal prepared by the particular preparer.

The process 1500 may include transmitting a notification regarding an availability of the meal for order to each user of the group of users 1508. In accordance with at least one embodiment, the notification may be transmitted to a user device of each user via a SMS message or via a user interface configured to be presented with the user device. The process may include receiving a reply to the transmitted notification from users about the order for the meal at 1510. The reply from the users may originate from the user device and in some examples may be via the same message channel provided to them (SMS message) or via a different communication channel (i.e., user interface interaction). The process 1500 may conclude at 1512 by authorizing the particular preparer to provide the meal to the location associated with the users in response to receiving the reply from the users. In some embodiments instructions may be provided to the particular preparer for delivering the meal to a vending machine in a common location or directly to each user.

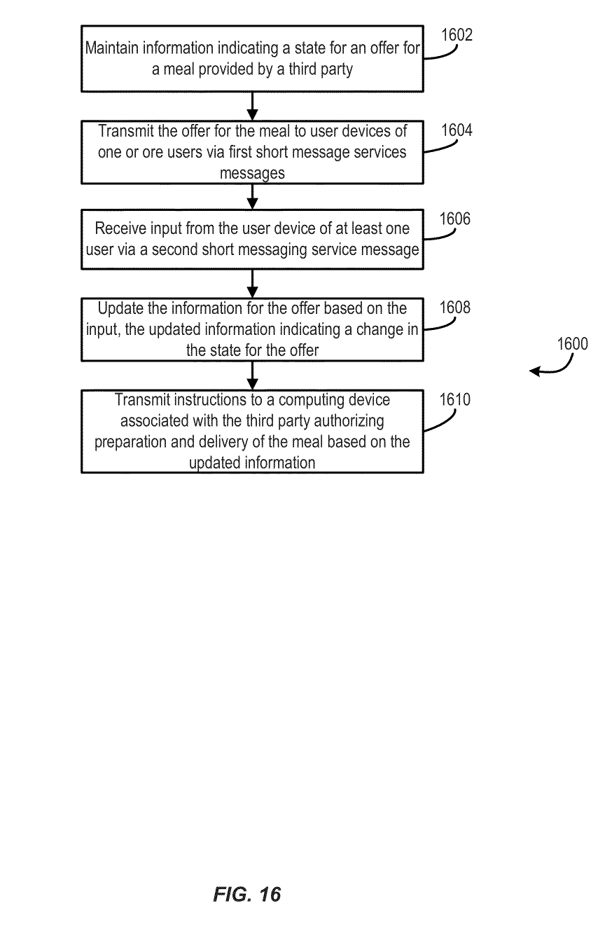

FIG. 16 illustrates an example flow diagram for an order management feature, according to embodiments. Some or all of the process 1600 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1600 may include maintaining information that indicates a state for an offer for a meal provided by a third-party at 1602. The information may be maintained by a computer or server associated with the service and implements the order management features described herein. The process 1600 may include transmitting the offer for the meal to user devices of one or more users selected on behalf of the third-party at 1604. In embodiments, the offer may be transmitted via short message service messages that are configured to be presented via the user devices associated with the users. In embodiments, the process 1600 may include receiving input about the offer from at least one user or one or more users at 1606. In some examples the input about the offer may be received by a computer system implementing the order management features via an available network and short messaging service messages. The process 1600 may include updating the information about the state for the offer based at least in part on the input at 1608. In accordance with at least one embodiment, the updated information indicates a change in the state for the offer of the meal. The information about the state may be maintained for each user of a plurality of users participating in the service described herein. The process 1600 may conclude at 1610 by transmitting instructions to a computing device associated with the third-party authorizing preparation and delivery of the meal to the users who ordered the meal presented in the offer. The instructions may be based at least in part on the updated information for the state of the offer. In embodiments, the instructions may also include optimized delivery route instructions that enable the third-party provider to deliver the meal to a common location or each user in an efficient manner.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A computer-implemented method for meal order management, comprising:
maintaining, by a computer system, information indicating a state of a workflow associated with an offer for a meal provided by a third party;
updating, by the computer system, the state of the workflow at least in response to transmission of the offer for the meal to a user device of one or more users selected on behalf of the third party, the offer transmitted through a first message channel as a first short message service message that is configured to be presented via the user device;
receiving, through the first message channel, a second short messaging service message that comprises input about the offer from the user device;
updating, by the computer system, the state of the workflow based at least in part on the input received from the user device; and
transmitting, though a second message channel, instructions to a computing device associated with the third party, the instructions for authorizing preparation and delivery of the meal to the one or more users based at least in part on the state of the workflow.

2. The computer-implemented method of claim 1, further comprising authorizing, by the computer system, a charge to an account of at least one user of the one or more users based at least in part on the input about the offer.

3. The computer-implemented method of claim 2, further comprising:
receiving, by the computer system, an indication that the charge to the account was declined; and
presenting, through the first message channel, a third short messaging service message to the user device of the at least one user, the third short messaging service message identifying that the charge to the account was declined, and the third short messaging service message generated by the computer system based at least in part on the state of the workflow when the indication is received.

4. The computer-implemented method of claim 3, wherein the third short messaging service message is configured to enable the at least one user, via a user interface presented on the user device, to update the account or decline the offer for the meal, and further comprising updating the state of the workflow when the at least one user declines the offer for the meal.

5. The computer-implemented method of claim 1, wherein the input about the offer includes a request for an alternative option to the meal included in the offer.

6. The computer-implemented method of claim 5, wherein the alternative option to the meal includes at least one of a lower calorie option than the meal of the offer, a vegetarian option of the meal, or a meat option of the meal.

7. The computer-implemented method of claim 1, further comprising presenting, through the first message channel, a third short messaging service message to the user device of the one or more users that comprises a request to review the meal provided by the third party, the request to review presented upon expiration of a time period associated with the meal.

8. The computer-implemented method of claim 7, wherein the time period is based at least in part on at least one of a type of food included in the meal or a number of meals ordered by the one or more users.

9. The computer-implemented method of claim 1, further comprising transmitting, through the second message channel, second instructions to the computing device associated with the third party, authorizing preparation and delivery of one or more orders of the meal in the offer in response to the updated state of the workflow indicating that the input about the offer included a request for the one or more orders of the meal provided by the third party.

10. The computer-implemented method of claim 1, wherein the state of the workflow indicates one or more actions associated with the offer for the meal provided by the third party, the one or more actions including at least one of instructing preparation of the meal, instructing preparation of an alternate meal, canceling the offer for the meal for a particular user, communicating with the third party, communicating with the one or more users, identifying a common location associated with the one or more users, charging accounts associated with the one or more users, or transmitting delivery instructions to the third party.

11. The computer-implemented method of claim 1, further comprising:
generating, by the computer system, a verification prompt provided through the first message channel that enables the one or more users to authorize or cancel the order for the meal provided by the third party based at least in part on the input about the offer and a library of responses, the verification prompt configured to be presented on the user device of the one or more users via a third short messaging service message; and
transmitting, through the first message channel, the verification prompt to the user device of the one or more users.

12. A computer system for meal order management, comprising:
one or more processors; and
memory, including instructions executable by the one or more processors to cause the computer system to at least:
maintain first information indicating a state of a workflow for an offer of a service provided by a third party;
transmit second information about the offer to a cluster of users selected on behalf of the third party, the second information transmitted via a first message through a first message channel to a user device of the cluster of users;
receive, through the first message channel, a second message that comprises input about the offer from the user device of a user of the cluster of users;
update the state of the workflow based at least in part on the received input, the updated state of the workflow indicating a change in the state for the offer of the service;
determine that an alternative offer is being requested by the user based at least in part on the updated state of the workflow and the received input; and
transmit, through the first message channel to the user device of the user, a third message that comprises third information about the determined alternative offer.

13. The computer system of claim 12, wherein the first message, second message, and third message are configured to be presented via a user interface of a software application of the user device associated with the user.

14. The computer system of claim 12, wherein the first information indicating the state of the workflow for the offer further identifies alternative service options that can be provided by the third party.

15. The computer system of claim 12, wherein the cluster of users is selected on behalf of the third party based at least in part on a common geographic location, demographic information for the cluster of users, or fourth information identifying that the cluster of users are employed by a same company.

16. One or more non-transitory computer-readable storage media having collectively stored thereon executable instructions for meal order management that, when executed by one or more processors of a computer system, cause the computer system to at least perform operations comprising:
in response to receiving, through a first message channel, a first short message service message comprising input from a user device of a user about an offer for an item provided by a third party:
determining that the user is no longer eligible for the offer of the item provided by the third party based at least in part on first information indicating a first time period indicating when the input was received and a second time period associated with the offer of the item;
updating second information that indicates a state of a workflow for the offer of the item based at least in part on the determination that the user is no longer eligible;
identifying a new offer for a different item provided by the third party based at least in part on the updated state of the workflow; and
transmitting, through the first message channel, a second short message service message to the user device of the user, the second short message service message comprising third information that identifies the new offer provided by the third party and that the offer for the first item has expired.

17. The one or more non-transitory computer-readable storage media of claim 16, wherein the item and the different item are meals provided by the third party and the meals are of a similar type of food.

18. The one or more non-transitory computer-readable storage media of claim 16, wherein the first message channel is a dedicated message channel.

19. The one or more non-transitory computer-readable storage media of claim 16, wherein the executable instructions when executed by the one or more processors of the computer system further cause the computer system to at least transmit, through the first message channel, a third short message service message comprising a request to review the item provided by the third party.

20. The one or more non-transitory computer-readable storage media of claim 19, wherein the state of the workflow for the offer is further updated based at least in part on a response received from the user device of the user about the request to review the item provided by the third party, the response received through the first message channel via a fourth short message service message.
